(19) United States
(12) Patent Application Publication
(10) Pub. No.: US 2021/0023705 A1
(43) Pub. Date: Jan. 28, 2021

(54) MOBILE ROBOT CAPABLE OF AVOIDING SUCTION-RESTRICTED OBJECT AND METHOD FOR AVOIDING SUCTION-RESTRICTED OBJECT OF MOBILE ROBOT

(71) Applicant: LG ELECTRONICS INC., Seoul (KR)

(72) Inventors: Jong Hoon CHAE, Seoul (KR); Beom Oh KIM, Suwon-si (KR); Tae Hyun KIM, Seoul (KR); Ji Chan MAENG, Seoul (KR)

(73) Assignee: LG ELECTRONICS INC., Seoul (KR)

(21) Appl. No.: 16/685,820

(22) Filed: Nov. 15, 2019

(30) Foreign Application Priority Data
Jul. 26, 2019 (KR) 10-2019-0090969

(51) Int. Cl. B25J 9/16; B25J 11/00

(52) U.S. Cl. CPC B25J 9/1666; B25J 9/163; B25J 11/0085

(57) ABSTRACT

The present disclosure may allow a cleaning robot to avoid a sensed object, the robot including one or more processors configured to project, via a projecting unit, an electromagnetic wave toward a movement path in which the cleaning robot is moving by operation of a driving unit; sense, via one or more sensors, an object positioned on the movement path based on electromagnetic waves reflected from the object; determine whether the sensed object is a type of restricted object by inputting information of the reflected electromagnetic waves to a machine learning model stored in a memory; measure an area corresponding to the sensed object; calculate an avoidance path to avoid the measured area and changing the movement path based on the calculated avoidance path; and operate the driving unit to avoid the sensed object based on the changed movement path.

### CROSS-REFERENCE TO RELATED APPLICATION

Pursuant to 35 U.S.C. § 119(a), this application claims the benefit of earlier filing date and right of priority to Korean Patent Application No. 10-2019-0090969, filed on Jul. 26, 2019 the contents of which are hereby incorporated by reference herein in its entirety.

### BACKGROUND

### 1. Technical Field

The present disclosure relates to an autonomous cleaning robot having learned a cleaning-restricted object in order to avoid the cleaning-restricted object and a method for avoiding the cleaning-restricted object of the cleaning robot. More specifically, the present disclosure relates to a technology that learns information on a cleaning-restricted object that should not be cleaned by a cleaning robot, and then in which the cleaning robot may move by avoiding the object if the sensed object coincides with the information learned by the robot when sensing the object around the robot.

### 2. Description of Related Art

The following description is provided only for the purpose of providing background information related to an embodiment of the present disclosure, and the contents to be described naturally do not constitute the related art.

A robot was developed for industrial use and was a part of factory automation. In recent years, the field of applications of robots has been further expanded, for example, a medical robot and an aerospace robot. Further, a home robot that may be used in an ordinary home is also being developed. Among these robots, a robot capable of traveling by itself is called a cleaning robot.

Particularly, a representative example of the cleaning robot used in the home may be a robot cleaner, and the robot cleaner is a device for cleaning a corresponding region by sweeping, vacuuming, or otherwise cleaning dust or foreign substances around the robot cleaner while traveling in a certain region by itself.

Specifically, the cleaning robot is capable of autonomous movement, and is equipped with a plurality of sensors that may avoid an obstacle during traveling.

For this purpose, an infrared sensor, an ultrasonic sensor, etc. may be installed in the cleaning robot. The infrared sensor is a configuration of determining the distance between the obstacle and the cleaning robot through the amount of reflected light returned by being reflected to the obstacle or the received time. On the other hand, the ultrasonic sensor is a configuration of emitting the ultrasonic wave having a predetermined period, and determining the distance with the obstacle by using the time difference between the ultrasonic emitting time and the moment returned by being reflected to the obstacle when there is the ultrasonic wave reflected by the obstacle.

Such a cleaning robot may determine the distance with the obstacle and also avoid the obstacle. For example, the ‘MOBILE ROBOT HAVING OBSTACLE AVOIDING FUNCTION AND METHOD THEREOF’ of Korean Patent No. 10-0669892 discloses a cleaning robot that includes a heterogeneous sensing sensor having different sensing regions, thereby enhancing the reliability of obstacle sensing and avoiding the obstacle with high reliability.

However, the above-described ‘MOBILE ROBOT HAVING OBSTACLE AVOIDING FUNCTION AND METHOD THEREOF’ is a technology that relates to obstacle avoidance that does not move, and there occurs a case where the obstacle is movable or an object, which is a certain level or less in size and should not be swept or vacuumed, for example, an object such as a valuable metal, is vacuumed and there is a limitation that does not avoid a specific object that should not be vacuumed.

As described above, in the case of considering only the situation for avoiding the fixed obstacle, there is a problem that does not avoid the object to which the cleaning robot should not be vacuumed.

Further, the ‘OBSTACLE DETECTION APPARATUS AND METHOD OF MOBILE ROBOT BASED ON MULTI-CHANNEL RIDER, AND MOBILE ROBOT HAVING THE SAME’ disclosed in Korean Patent No. 10-1878827 proposes an obstacle detection method of a mobile robot based on a multi-channel rider. The corresponding disclosure proposes a technology that may measure the distance between the obstacle and the mobile robot by acquiring the surrounding environment in which the mobile robot travels as three-dimensional spatial information, and avoid the collision with the obstacle according to the measured distance.

This ‘OBSTACLE DETECTION APPARATUS AND METHOD OF MOBILE ROBOT BASED ON MULTI-CHANNEL RIDER, AND MOBILE ROBOT HAVING THE SAME’ extracts the vertical environment such as a wall and the obstacle through the three-dimensional spatial information, and plans the traveling path of the mobile robot based on the distance with the extracted vertical environment and obstacle.

The disclosed ‘OBSTACLE DETECTION APPARATUS AND METHOD OF MOBILE ROBOT BASED ON MULTI-CHANNEL RIDER, AND MOBILE ROBOT HAVING THE SAME’ proposes a technology that may detect the obstacle, but there is a limitation in which it is difficult to avoid by determining it as the obstacle if the obstacle is the flowable pollutant or a small size of the object that should not be sucked by the mobile robot.

Accordingly, there is a need for a method in which the cleaning robot may avoid the flowable pollutant or the object, which should not be vacuumed.

### RELATED ART DOCUMENTS

(Patent Document 1) Korean Patent No. 10-0669892 (Jan. 10, 2007)

(Patent Document 2) Korean Patent No. 10-1878827 (Jul. 10, 2018)

### SUMMARY OF THE DISCLOSURE

An object of the present disclosure is to allow a cleaning robot to avoid a cleaning-restricted object, which may be vacuumed or otherwise cleaned up, but should not be vacuumed such as the flowable pollutant, an object of a predetermined size or less, or an object containing a predetermined moisture, without suction.

Another object of the present disclosure is to allow the cleaning robot not to vacuum the cleaning-restricted object based on learned data when the sensed object is a cleaning-restricted object by sensing an object around the cleaning robot after the cleaning robot learns the cleaning-restricted object.

Still another object of the present disclosure is to control the driving of the cleaning robot so that the cleaning robot may avoid the cleaning-restricted object and move when the sensed object is the cleaning-restricted object by sensing an object around the cleaning robot after the cleaning robot learns the cleaning-restricted object.

Yet another object of the present disclosure is to allow the cleaning robot to remove the cleaning-restricted object by notifying a user who uses the cleaning robot of relevant information while stopping the driving of the cleaning robot, when the object vacuumed by the cleaning robot is the cleaning-restricted object after the cleaning robot learns the cleaning-restricted object.

For achieving the objects, a method for avoiding a cleaning-restricted object of a cleaning robot according to an embodiment of the present disclosure may be performed in the process of acquiring data receiving a data set labeled as the cleaning-restricted object, training a machine learning model for determining the cleaning-restricted object based on the acquired data set, then sensing an object positioned on the movement path of the cleaning robot, determining whether the sensed object is the cleaning-restricted object based on the machine learning model, and then driving the cleaning robot to avoid the object, when the object is the cleaning-restricted object.

That is, it is possible to minimize the suction of the cleaning-restricted object by the cleaning robot so that the cleaning robot avoids the cleaning-restricted object without suction when the sensed object is the cleaning-restricted object, by sensing an object around the cleaning robot after the cleaning robot learns the cleaning-restricted object.

When the data is acquired in the method for avoiding the cleaning-restricted object of the cleaning robot according to an embodiment of the present disclosure, the labeled data set, which includes an image of one of a flowable pollutant, a metal object of a predetermined size or less, and a pollutant containing a predetermined moisture, which are marked as the cleaning-restricted object, may be input.

For example, the cleaning-restricted object may be one of a material made of liquid, a flowing object containing moisture, or a product such as a valuable metal of a user living in a space where the cleaning robot moves, and the data set, which includes the image of the cleaning-restricted object and has labeled these images as the cleaning-restricted object, is input to the cleaning robot.

When the object is sensed in the method for avoiding the cleaning-restricted object of the cleaning robot according to an embodiment of the present disclosure, a predetermined electromagnetic wave may be radiated toward the sensed object, and the object may be sensed through a process of measuring a reflected electromagnetic wave.

Specifically, the cleaning robot may radiate the electromagnetic wave or the laser toward the object, and determine whether the object is a liquid or flowable material by measuring the electromagnetic wave that the radiated electromagnetic wave or laser is returned from the object toward the cleaning robot.

When it is determined that the thus determined object is liquid, it may be determined as the cleaning-restricted object so that the suction of the cleaning robot is limited or the cleaning robot moves by avoiding it.

When the object is sensed in the method for avoiding the cleaning-restricted object of the cleaning robot according to an embodiment of the present disclosure, the region of the sensed object may be sensed. Thereinafter, the avoidance path of the cleaning robot may be set to avoid the region of the object, and the movement path of the cleaning robot may be reset along the avoidance path to be set.

As described above, it is possible to prevent the cleaning robot from closing to the cleaning-restricted object or moving over the cleaning-restricted object by resetting the movement path of the cleaning robot having sensed the cleaning-restricted object, thereby minimizing the cleaning robot to vacuum the cleaning-restricted object.

When the cleaning robot vacuums the cleaning-restricted object before avoiding the cleaning-restricted object in the method for avoiding the cleaning-restricted object of the cleaning robot according to an embodiment of the present disclosure, the traveling of the cleaning robot may be stopped, and then the notification of whether the cleaning-restricted object has been vacuumed may be transmitted to a user of the cleaning robot.

Accordingly, it is possible to restrict the additional movement of the cleaning robot having vacuumed the cleaning-restricted object, and at the same time, to notify the user of the suction of the cleaning-restricted object so that the user may remove the cleaning-restricted object vacuumed by the cleaning robot from the cleaning robot, thereby preventing the loss of valuables or the spread of pollutants.

Meanwhile, a cleaning robot according to an embodiment of the present disclosure, as one capable of avoiding a cleaning-restricted object, may be configured to include a main body of the cleaning robot, a driving unit for moving the main body, a sensor provided in the main body and capable of sensing an object around the cleaning robot, a memory for storing a computer readable program, and a control unit for controlling the cleaning robot by communicating with the memory, the driving unit, and the sensor.

At this time, the memory stores a machine learning model trained by data set labeled as the cleaning-restricted object, and the control unit determines whether the object sensed by the sensor is the cleaning-restricted object based on the machine learning model, and controls the driving unit to avoid the object when the object is the cleaning-restricted object.

That is, the cleaning robot according to an embodiment of the present disclosure may avoid the cleaning-restricted object without suction when the sensed object is the cleaning-restricted object by sensing an object around the cleaning robot after the cleaning robot learns the cleaning-restricted object, thereby minimizing the cleaning robot to vacuum the cleaning-restricted object.

The labeled data set stored in the memory of the cleaning robot according to an embodiment of the present disclosure may be an image of one of a flowable pollutant, a metal object of a predetermined size or less, and a pollutant containing a predetermined moisture, which are marked as the cleaning-restricted object.

For example, the cleaning-restricted object may be one of a material made of liquid and a product such as a valuable metal of the user living in a space where the cleaning robot moves, and the data set with the image of the cleaning-restricted object labeled is input to the cleaning robot.

Meanwhile, training composed of the data set labeled as the cleaning-restricted object may be performed outside other than the cleaning robot, and only the cleaning-restricted object sensing model derived as the result of the training may also be transferred to the cleaning robot.

The sensor of the cleaning robot according to an embodiment of the present disclosure may radiate a predetermined electromagnetic wave to the object around the cleaning robot.

Specifically, the cleaning robot may radiate the laser toward the object, and determine whether the object is a flowable material by measuring the region of the electromagnetic wave that the radiated laser is returned from the object toward the cleaning robot.

At this time, the control unit of the cleaning robot according to an embodiment of the present disclosure may determine the object as the cleaning-restricted object when it is determined that the object is liquid by analyzing the predetermined electromagnetic wave reflected from the object.

The sensor of the cleaning robot according to an embodiment of the present disclosure may measure the region of the object, and the control unit may control the driving unit along the movement path of the cleaning robot reset to avoid the measured region of the object.

As described above, it is possible to prevent the cleaning robot from moving around the cleaning-restricted object by resetting the movement path of the cleaning robot having sensed the cleaning-restricted object, thereby minimizing the cleaning robot to vacuum the cleaning-restricted object.

Meanwhile, a cleaning robot according to an embodiment of the present disclosure, as one capable of avoiding a cleaning-restricted object, includes a determination model generating unit for learning data set labeled as the cleaning-restricted object, and generating a determination model on the learned cleaning-restricted object, a sensing sensor capable of sensing around the cleaning robot, and a control unit for controlling the motion of the cleaning robot by communicating with the sensing sensor, and the control unit determines whether the object sensed by the sensing sensor is the cleaning-restricted object by using the determination model, and then controls the motion of the cleaning robot to avoid the cleaning-restricted object and move the cleaning robot when the object is determined as the cleaning-restricted object.

Meanwhile, a method for operating a cleaning robot according to an embodiment of the present disclosure, sensing an object positioned on a movement path of the cleaning robot, determining whether the sensed object corresponds to a cleaning-restricted object using a stored machine learning model, wherein the stored machine learning model is trained to identify a cleaning-restricted object based on a data set labeled as cleaning-restricted objects and driving the cleaning robot to avoid the sensed object when the sensed object is determined as a cleaning-restricted object.

And meanwhile, a cleaning robot according to an embodiment of the present disclosure, a driving unit, a sensor configured to sense an object around the cleaning robot, a memory storing a machine learning model, wherein the stored machine learning model is trained to identify a cleaning-restricted object based on a data set labeled as cleaning-restricted objects and a control unit configured to, determine whether the sensed object corresponds to a cleaning-restricted object based on the machine learning model and control the driving unit to avoid the object when the sensed object is determined to correspond to the cleaning-restricted object.

And meanwhile, a cleaning robot according to an embodiment of the present disclosure, a determination model generating unit configured to train a determination model for identifying a cleaning-restricted object based on a learning data set labeled as cleaning-restricted objects, a sensor configured to sense objects around the cleaning robot and a control unit configured to, control movement of the cleaning robot along a movement path, determine whether an object sensed by the sensor on the movement path corresponds to a cleaning-restricted object using the determination model and control movement of the cleaning robot to avoid the sensed object by adjusting the movement path when the sensed object is determined to correspond to a cleaning-restricted object.

According to the embodiments of the present disclosure, in the process of movement of the cleanable cleaning robot along the movement path, it is possible to avoid the cleaning-restricted object, which may be vacuumed but is cleaning-restricted, such as the flowable pollutant, the object of a predetermined size or less, or the pollutant containing a predetermined moisture, without suction. Accordingly, it is possible for the cleaning robot to vacuum the pollutant containing moisture during cleaning, and to prevent the cleaned region from being re-polluted by the pollutant

Further, the cleaning-restricted object sensing model derived by machine-learning through the data set labeled as the cleaning-restricted object so that the cleaning robot does not vacuum the cleaning-restricted object may determine whether the object sensed by the cleaning robot is a cleaning-restricted object. That is, in the case where the object around the cleaning robot has been sensed, the object sensed based on the learned data may be prevented from being vacuumed when it is the cleaning-restricted object, thereby preventing the object (e.g., a noble metal, etc.) from being vacuumed.

Further, according to the embodiments of the present disclosure, it is possible to notify the user of the cleaning robot whether the cleaning-restricted object has been vacuumed while stopping the driving of the cleaning robot, when the cleaning robot vacuums the cleaning-restricted object during movement along the movement path, after learning the cleaning-restricted object. For example, if the cleaning robot vacuums the pollutant containing moisture and the user recognizes it, the user may remove the pollutant from the cleaning robot. Accordingly, it is possible to prevent the cleaning robot from moving in a state where the pollutant containing moisture has been attached to the cleaning robot, thereby preventing the space where the cleaning robot moves from being re-polluted.

### BRIEF DESCRIPTION OF THE DRAWINGS

FIG. 1 is a diagram showing an embodiment in which a cleaning robot capable of avoiding pollutant according to an embodiment of the present disclosure has been implemented.

FIG. 2 is a block diagram showing the cleaning robot according to an embodiment of the present disclosure.

FIG. 3 is a block diagram showing the relationship between a memory, a control unit, and a driving unit of FIG. 2.

FIG. 4 is a diagram showing an embodiment in which the cleaning robot of FIG. 1 avoids it when sensing pollutant in the process of moving along the movement path.

FIG. 5 is a diagram showing an embodiment in which the cleaning robot according to an embodiment of the present disclosure determines a cleaning-restricted object by using an electromagnetic wave.

FIG. 6 is a diagram showing a method for resetting the movement path of the cleaning robot, when the cleaning robot according to an embodiment of the present disclosure senses the cleaning-restricted object in the process of moving along the movement path.

FIG. 6A is a initial movement path of the cleaning robot, FIG. 6B is an embodiment in which the cleaning robot has sensed the cleaning-restricted object, and FIG. 6C shows the movement path of the cleaning robot that avoids the cleaning-restricted object and has been reset.

FIG. 7 is a flowchart showing a process in which the cleaning robot learns the cleaning-restricted object according to an embodiment of the present disclosure.

FIG. 8 is a flowchart showing a cleaning-restricted object avoiding process of the cleaning robot when the cleaning robot senses the cleaning-restricted object during movement in a state having learned the cleaning-restricted object of FIG. 7.

FIG. 9 is a flowchart showing the drive restriction of the cleaning robot when the cleaning robot has vacuumed the cleaning-restricted object during movement in a state having learned the cleaning-restricted object of FIG. 7.

### DETAILED DESCRIPTION

Hereinafter, the present disclosure will be described in detail with reference to the drawings. The present disclosure may be embodied in many different forms, and is not limited to the embodiments described herein. In the following embodiments, parts that are not directly related to the description will be omitted in order to clearly illustrate the present disclosure, but in implementing an apparatus or a system to which the spirit of the present disclosure has been applied, it is not meant that the thus omitted configuration is unnecessary. Further, the same reference numerals are used for the same or similar components throughout the specification.

In the following description, the terms “first”, “second”, etc. may be used to describe various components, but the components should not be limited by the terms, and the terms are used only for the purpose of distinguishing one component from another. Further, in the following description, the singular expression includes plural expression unless the context clearly dictates otherwise.

In the following description, it should be understood that the terms such as “comprises” or “having” are used to specify that there are a feature, a number, a step, an operation, a component, a part, or a combination thereof described in the specification, but do not preclude the presence or addition of one or more other features, numbers, steps, operations, components, parts, or combinations thereof in advance.

Hereinafter, an autonomous cleaning robot capable of avoiding pollutant through a cleaning-restricted object avoiding method of the present disclosure will be described in detail with reference to the drawings.

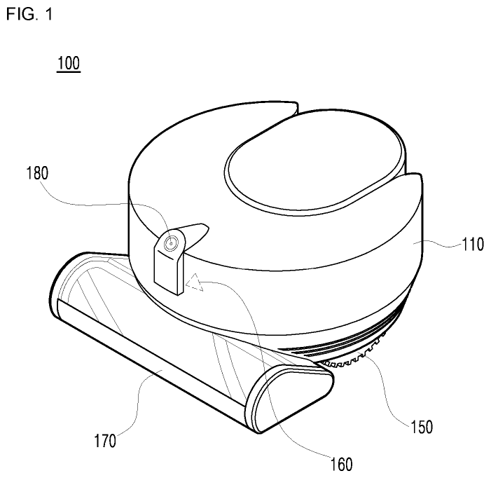

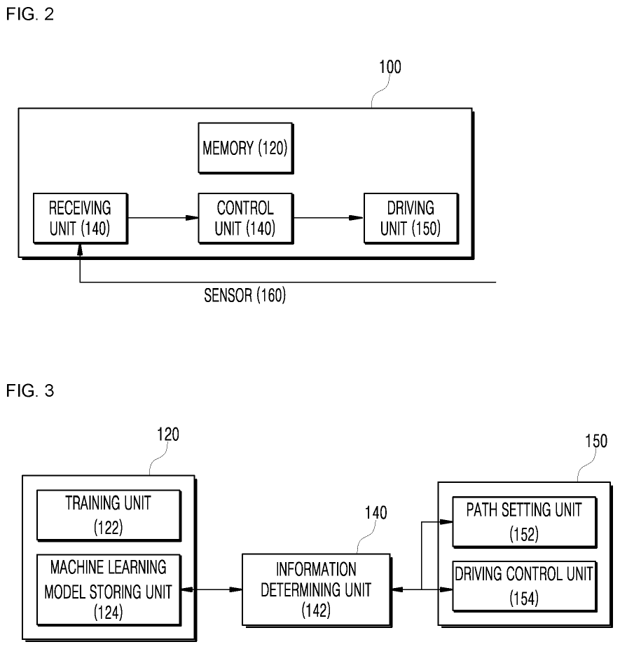

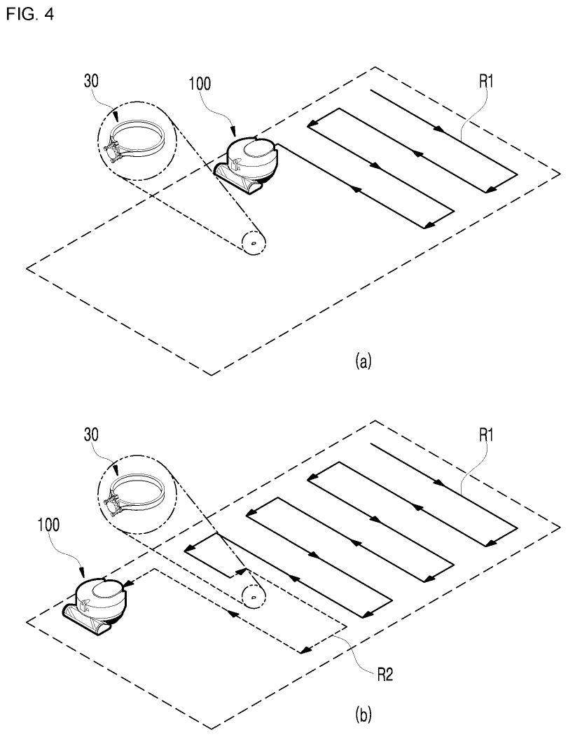

FIG. 1 is a diagram showing an embodiment in which a cleaning robot capable of avoiding pollutant according to an embodiment of the present disclosure has been implemented, FIG. 2 is a block diagram showing the cleaning robot according to an embodiment of the present disclosure, and FIG. 3 is a block diagram showing the relationship between a memory, a control unit, and a driving unit of FIG. 2.

Although it will be described that the cleaning robot according to an embodiment of the present disclosure is, an autonomous cleaning robot, for example, a cleaning robot capable of autonomous travel, it is natural that the cleaning robot may be operated in semi-autonomous or passive modes in addition to autonomous travel. Further, the cleaning robot capable of machine learning and autonomous travel in an embodiment of the present disclosure may be one of robots capable of operating in autonomous, semi-autonomous, etc. modes in addition to a cleaning robot.

A cleaning robot 100 according to an embodiment of the present disclosure may vacuum an object (e.g., dust, garbage, etc.) positioned on the entire surface of the cleaning robot 100 while moving along the movement path. In some cases, the cleaning robot according to other embodiments may clean objects by sweeping, mopping, polishing, or otherwise clearing the dust, garbage, or debris, as will be understood by those of ordinary skill in the art.

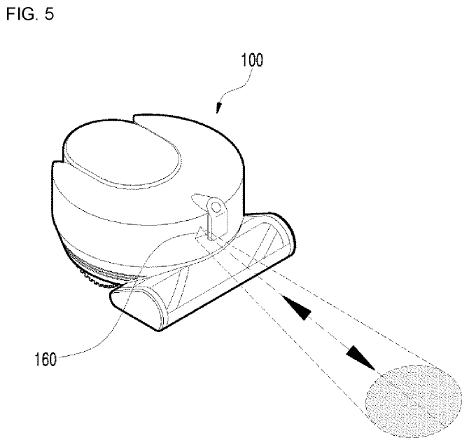

When vacuuming an object while moving along the movement path, the cleaning robot 100 may be configured to vacuum objects, and avoid objects that should not be vacuumed (hereinafter referred to as a cleaning-restricted object see 30 in FIG. 4) and move.

Specifically, the cleaning-restricted object may one object of a product marked as a cleaning-restricted object, a flowable pollutant such as water, a metal object of a predetermined size or less such as a valuable or noble metal, or a pollutant containing a predetermined moisture such as defecation of a companion animal living in the home.

Particularly, when vacuuming foreign substances while moving, the cleaning robot 100 of an embodiment of the present disclosure may be configured to limit the cleaning-restricted object that is not vacuumed to avoid it when the cleaning-restricted object is sensed. That is, the cleaning robot 100 may be configured to automatically vacuum foreign substances of the peripheries while moving. If the cleaning robot 100 vacuums the pollutant containing moisture, the cleaning robot 100 are moved to another region in a state having vacuumed the pollutant containing moisture, such that there occurs a case where the cleaned region is also re-polluted by the pollutant containing moisture. However, since the cleaning robot 100 according to an embodiment of the present disclosure may avoid the cleaning-restricted object such as the pollutant containing moisture and move, the movement path of the cleaning robot 100 may be prevented from being re-polluted by the pollutant while the cleaning robot 100 moves.

In order for the cleaning robot 100 to avoid the cleaning-restricted object such as the pollutant containing moisture and move, it is necessary to learn information about the cleaning-restricted object. For this purpose, the cleaning robot 100 may be configured to include a main body 110 for forming the outer shape of the cleaning robot 100, a driving unit 150 for driving the main body 110 so that the main body 110 may move and rotate, a sensor 160 provided in the main body 110 and capable of sensing an object around the cleaning robot 100, a memory 120 in which a computer readable program has been stored, and a control unit 140 for controlling the cleaning robot 100 by communicating with the memory 120, the driving unit 150, and the sensor 160.

Specifically, the main body 110 may be formed of one of various shapes such as a circular shape and a polygonal shape, and the shape of the main body 110 may be changed according to conditions.

Further, the main body 110 may be formed with a suction unit 170 through which dust, foreign substances, etc. may be sucked or vacuumed, and the main body 110 may be configured to include a suction apparatus (not shown), a dust collecting container capable of collecting the sucked dust, etc. so that dust, foreign substances, etc. may be vacuumed through the suction unit 170.

Further, a camera 180 capable of sensing the front may be installed in the main body 110. The camera 180 may photograph the peripheries of the cleaning robot 100, and the video or image information photographed by the camera 180 may be transmitted to a sensor 160 described later.

Meanwhile, a battery (not shown) may be installed in the main body 110. The battery may supply power necessary for the overall operation of the cleaning robot 100 in addition to the driving unit 150 described later. When such a battery is discharged, a charging dock (not shown) capable of charging the battery may be installed in the moving space of the cleaning robot 100, and the cleaning robot 100 may be configured so that the cleaning robot 100 may detect the position of the charging dock by itself during the return traveling while performing travel back to the charging dock at an appropriate time.

The driving unit 150 may include at least one driving wheel capable of rotating and moving the main body 110, and the driving wheel may be prepared on one surface of the main body 110, but a structure in which the driving wheel is installed may be changed according to the conditions. Meanwhile, the main body 110 or the driving unit 150 may be driven by including a separate driving motor capable of driving the driving wheel.

The sensor 160 may be installed in the main body 110 to sense an object that may be vacuumed by the main body 110 around the main body 110, when the main body 110 rotates and moves. When the sensor 160 senses an object around the main body 110, it is necessary to determine whether the object sensed by the sensor 160 is a cleanable object in order to determine whether the main body 110 vacuums it.

For this purpose, the memory 120 may store a machine learning model trained by the data set labeled as the cleaning-restricted object. At this time, when the object sensed by the sensor 160 corresponds to cleaning-restricted object learning information learned in the memory 120, the control unit 140 controls the driving unit 150 so that the cleaning robot 100 may avoid the cleaning-restricted object and move.

Specifically, the memory 120 for learning the information of the cleaning-restricted object includes a machine learning model storing unit 124 and a training unit 122 so that the cleaning robot 100 does not vacuum the cleaning-restricted object.

The machine learning model storing unit 124 may store the information of the cleaning-restricted object of the cleaning robot 100 as an image. The information of the cleaning-restricted object stored as the image may be, for example, images such as a product marked as a cleaning-restricted object, a flowable pollutant such as water, a metal object of a predetermined size or less such as a noble metal, or a pollutant containing a predetermined moisture such as defecation of a companion animal living in the home.

As described above, when the information of the cleaning-restricted object is stored in the machine learning model storing unit 124, the training unit 122 may perform training on the cleaning-restricted object based on the stored information of the cleaning-restricted object.

Meanwhile, the training may be performed in the cleaning robot 100 itself but may be performed outside rather than the cleaning robot 100, and only the cleaning-restricted object sensing model derived from the training results may also be transmitted to the cleaning robot 100.

As described above, in a state where the information of the cleaning-restricted object has been stored and trained, the cleaning robot 100 may sense an object around the cleaning robot 100 through the sensor 160 while moving along the movement path (see the sensor 160 in FIG. 2).

The sensing result of the sensor 160 may be transmitted to a receiving unit 130, and the sensing result of the sensor 160 transmitted to the receiving unit 130 may be determined as to whether it corresponds to the learned information of the cleaning-restricted object through an information determining unit 142 of the control unit 140.

That is, the sensor 160 senses an object around the cleaning robot 100 through image recognition, electromagnetic wave change, etc., and the information determining unit 142 determines whether the sensed object corresponds to the learned information of the cleaning-restricted object.

As described above, if it is determined whether the sensed object corresponds to the learned information of the cleaning-restricted object, and the sensed object corresponds to the learned information of the cleaning-restricted object as the determination result, a path setting unit 152 of the driving unit 150 may be configured so that the cleaning robot 100 may reset the movement path not to vacuum the cleaning-restricted object.

At this time, the cleaning robot 100 may vacuum the cleaning-restricted object even in any situation of a state where the cleaning robot 100 has recognized that the sensed object is a cleaning-restricted object, or a state where it has not recognized that the sensed object is a cleaning-restricted object. In this case, the cleaning robot 100 may stop driving immediately, and inform the user of the cleaning robot 100 whether the cleaning-restricted object has been vacuumed.

More specifically, when it is determined that the cleaning robot 100 has vacuumed the cleaning-restricted object, a driving control unit 154 controls the driving of the cleaning robot 100, thereby preventing the surrounding region not polluted by the pollutant from being polluted due to the additional movement of the cleaning robot 100.

Through the above-described configuration of the cleaning robot 100, it is possible to avoid the cleaning-restricted object, which may be vacuumed but is cleaning-restricted such as a flowable pollutant, an object of a predetermined size or less, or a pollutant containing a predetermined moisture, without suction and move while the cleanable cleaning robot 100 moves along the movement path.

Accordingly, the cleaning robot 100 may avoid the pollutant containing moisture (e.g., beverage), etc. which is a cleaning-restricted object, during cleaning, thereby preventing the movement path from being re-polluted by the cleaning robot 100 moving along the movement path in a state having vacuumed the cleaning-restricted object.

Further, the cleaning robot 100 may sense an object in a state having machine-learned the data set labeled as the cleaning-restricted object not to vacuum the cleaning-restricted object, and automatically avoid the object according to whether the sensed object corresponds to the learned information of the cleaning-restricted object.

As described above, a process of the cleaning robot 100 capable of changing the movement path of the cleaning robot 100 not to vacuum the cleaning-restricted object when sensing the cleaning-restricted object will be described in more detail with reference to FIG. 4.

Referring to FIG. 4, the cleaning robot 100 has learned the information of the cleaning-restricted object 30 that should not be vacuumed by the main body 110 while the cleaning robot 100 moves. Such learning information may be an image on one object such as a product marked as the cleaning-restricted object 30, a flowable pollutant such as water, a metal object of a predetermined size or less such as a noble metal, or a pollutant containing a predetermined moisture such as defecation of a companion animal living in the home, and such an image may be stored in the memory 120. In a state having learned the learning information, the sensor 160 may sense the object around the cleaning robot 100 while the cleaning robot 100 moves along an initially set movement path (R1) (see FIG. 4A). When the type of the object sensed by the sensor 160 corresponds to the previously learned learning information, the control unit 140 may reset the movement path by changing the initially set movement path (R1) of the cleaning robot 100 (see R2). As described above, when the object is the cleaning-restricted object 30, the path of the cleaning robot 100 is restricted so that the cleaning robot 100 configured to automatically vacuum the surrounding foreign substances fundamentally avoids the cleaning-restricted object 30 to disable the suction of the cleaning-restricted object 30 (see FIG. 4B).

Hereinafter, an embodiment in which the sensor 160 of the cleaning robot 100 determines the cleaning-restricted object will be described in detail with reference to the drawings.

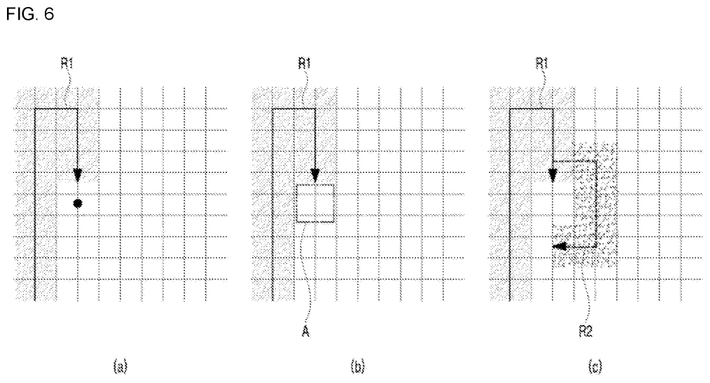

FIG. 5 is a diagram showing an embodiment in which the cleaning robot according to an embodiment of the present disclosure determines the cleaning-restricted object by using the electromagnetic wave.

Referring to FIG. 5, the sensor 160 of the cleaning robot 100 may radiate a predetermined electromagnetic wave toward the surroundings of the cleaning robot 100. For example, the radiated electromagnetic wave may be a laser sensor, and when the cleaning robot 100 moves along the movement path, the laser may be radiated toward the movement path.

At this time, when the laser has been radiated toward the object and the object is a pollutant containing moisture, the returned electromagnetic wave of the laser, which is radiated to the object and returned back to the sensor 160, may generally be different from the returned electromagnetic wave of the laser that radiates the periphery of the cleaning robot 100 having no object.

The control unit 140 may sense a change in the returned electromagnetic wave of the laser. That is, the control unit 140 may analyze the electromagnetic wave reflected from the object. At this time, the memory 120 previously stores electromagnetic wave information reflected from the cleaning-restricted object, electromagnetic wave information reflected by the movement path having no the object, and electromagnetic wave information reflected from the object, in particular, electromagnetic wave information reflected from the pollutant of liquid containing moisture, and when the electromagnetic wave information reflected from the object is particularly the same as the electromagnetic wave information reflected from the pollutant of the liquid containing moisture, it is determined that the object sensed by the sensor 160 is a pollutant containing moisture to assume the sensed object as the cleaning-restricted object.

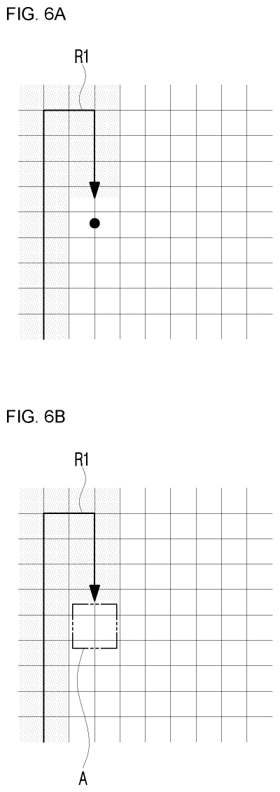

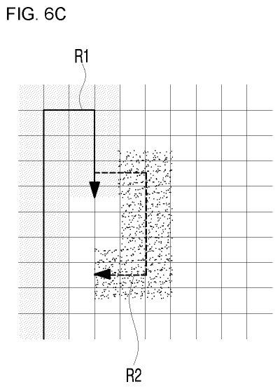

Alternatively, the sensor 160 may measure the region of the object, and reset the movement path of the cleaning robot 100 according to the region of the measured object. Hereinafter, an embodiment related to the present disclosure will be described in detail with reference to FIG. 6.

FIG. 6 is a diagram showing a method for resetting the movement path of the cleaning robot, when the cleaning robot according to an embodiment of the present disclosure senses the cleaning-restricted object in the process of moving along the movement path.

Referring to FIG. 6, first, the movement path has been set in the cleaning robot 100 regardless of whether the cleaning-restricted object has been sensed (hereinafter referred to as an initial movement path R1). The cleaning robot 100 may move along the set initial movement path and vacuum foreign substances around itself.

In this process, the sensor 160 of the cleaning robot 100 may sense an object around the cleaning robot 100. When it is determined that the sensed object is a cleaning-restricted object, the region of the object, which is the cleaning-restricted object, may be measured to avoid it and move.

The measurement of the region of the object may be meant to measure the width where the object has been distributed on the movement path of the cleaning robot 100. This is because it is possible to calculate the avoidance path, which may avoid the object determined as the cleaning-restricted object, only when it is determined what the object is distributed to any degree of the width.

For this purpose, it is preferable that the movement path through which the cleaning robot 100 moves is partitioned into a constant width. At this time, the condition of the width for partitioning the movement path may be preset in the cleaning robot 100, and the movement path may be partitioned into various widths under various conditions.

Since the movement path is partitioned by a constant width, it may be determined whether the object is distributed to any degree of the width. For example, as shown in FIG. 6, it is assumed that the entire path through which the cleaning robot 100 moves has been partitioned into a constant width, and as shown in FIG. 6B, it may be determined that the object has been distributed within a specific region A (see FIG. 6B).

As described above, when it is determined that the object is distributed to any degree of the width, the cleaning robot may avoid the region where the object has been distributed to reset a new movement path where the cleaning robot 100 may move (R2). That is, as shown in FIG. 6C, the reset movement path of the cleaning robot 100 avoids the region A where the object has been distributed and is newly set.

As described above, when it is determined that the object sensed by the sensor 160 is a cleaning-restricted object, the cleaning robot 100 resets the movement path while avoiding the region where the object has been distributed by measuring the region of the object that is the cleaning-restricted object (see R2 in FIG. 6C), thereby preventing the cleaning robot 100, which automatically vacuums the foreign substances around itself, from vacuuming the cleaning-restricted object.

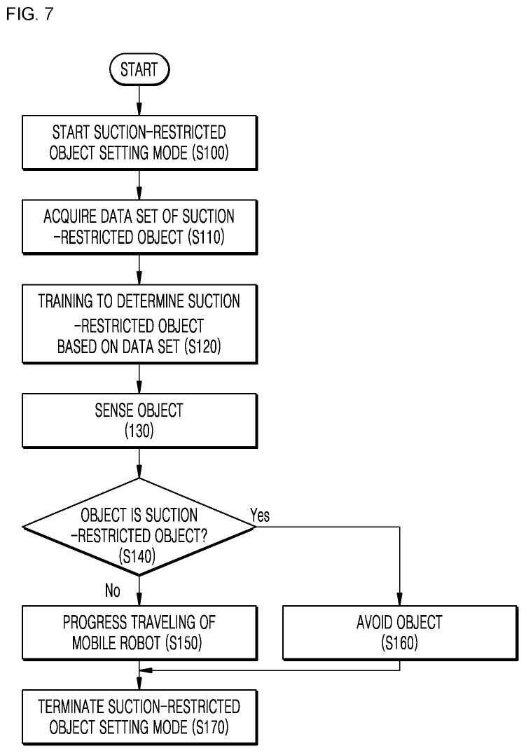

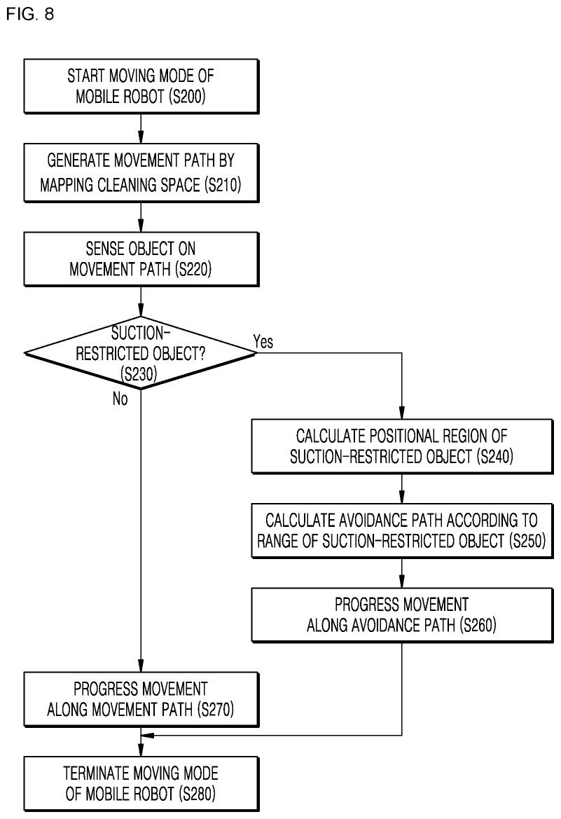

Hereinafter, a method in which the cleaning robot avoids the cleaning-restricted object will be described with reference to FIGS. 7 and 8.

FIG. 7 is a flowchart showing a process in which the cleaning robot learns the cleaning-restricted object according to an embodiment of the present disclosure, and FIG. 8 is a flowchart showing a process in which the cleaning robot avoids the cleaning-restricted object when the cleaning robot senses the cleaning-restricted object during movement in a state having learned the cleaning-restricted object of FIG. 7.

Before describing the drawings, when the reference numerals described in FIGS. 7 and 8 are the same as the reference numerals shown in FIGS. 1 to 6, they are determined as the same configuration, and a detailed description thereof will be omitted.

The cleaning robot 100 according to an embodiment of the present disclosure is an apparatus for automatically vacuuming the objects such as dust and garbage positioned around the cleaning robot 100 while moving along the movement path.

When vacuuming the object while moving along the movement path, the cleaning robot 100 is configured to vacuum an object, and to avoid objects that should not be vacuumed (hereinafter referred to as cleaning-restricted object) and move.

In order for the cleaning robot 100 to avoid the cleaning-restricted object such as the pollutant containing moisture and move, the information about the cleaning-restricted object should be set (S100).

Referring to FIG. 7, before avoiding the cleaning-restricted object the cleaning robot 100 may acquire the information of the cleaning-restricted object that should be avoided. That is, the cleaning robot 100 may receive the data set labeled as the cleaning-restricted object (S110).

Specifically, the cleaning-restricted object may be one object such as a product marked as a cleaning-restricted object, a flowable pollutant such as water, a metal object of a predetermined size or less such as a valuable or noble metal, or a pollutant containing a predetermined moisture such as defecation of a companion animal living in the home.

Thereinafter, training may be performed to determine the cleaning-restricted object based on the input data set (S120). The training means a process of machine-learning and storing an image of the above-described cleaning-restricted object, and at this time, may be information that may allow the cleaning robot 100 to avoid the object and drive when the learned and stored image is compared with an image of the sensed object described later and the sensed object is a cleaning-restricted object.

After training the data set, the cleaning robot 100 may move along the movement path and sense an object around the cleaning robot 100 (S130). At this time, the sensor 160 installed in the cleaning robot 100 senses around the cleaning robot 100 and senses the object.

When the sensor 160 senses an object around the cleaning robot 100, it is determined whether the sensed object is a cleaning-restricted object (S140). Specifically, the sensed result of the sensor 160 may determine whether it corresponds to the information of the cleaning-restricted object previously learned by the training.

That is, the sensor 160 may sense an object around the cleaning robot 100 through image recognition, electromagnetic wave change, etc., and determine whether the sensed object corresponds to the learned information of the cleaning-restricted object.

Specifically, the sensor 160 may be implemented as a laser sensor, and may radiate a laser toward the movement path, when the cleaning robot 100 moves along the movement path.

At this time, when the laser has been radiated toward the object and the object is a pollutant containing moisture, the returned electromagnetic wave of the laser, which is radiated to the object and returned back to the sensor 160, may be generally different from the returned electromagnetic wave of the laser, which radiates the periphery of the cleaning robot 100 having no object.

A change in the laser returned electromagnetic wave is sensed. That is, predetermined electromagnetic wave information reflected from the cleaning-restricted object, electromagnetic wave information reflected on the movement path having no object, and electromagnetic wave information reflected from the object, particularly, electromagnetic wave information reflected from the pollutant of liquid containing moisture may be previously stored, and when the electromagnetic wave information reflected from the object in which the radiated electromagnetic wave region has been previously stored is particularly the same as the electromagnetic wave information reflected from the pollutant of liquid containing moisture, the object sensed by the sensor 160 is determined as the pollutant containing moisture and the sensed object is assumed as the cleaning-restricted object.

Alternatively, after the stored image of the cleaning-restricted object is compared with the image of the object photographed by the camera 180 based on the machine learning model, the object may be determined as the cleaning-restricted object when the image of the learned cleaning-restricted object corresponds to the image of the photographed object.

According to this method, it may determine whether the sensed object corresponds to the learned information of the cleaning-restricted object, and when the sensed object and the learned information of the cleaning-restricted object do not correspond to each other as the determination result, the cleaning robot 100 may continue to travel, and the cleaning-restricted object setting mode of the cleaning robot 100 may be terminated (S150, S170).

Alternatively, it is determined whether the sensed object corresponds to the learned information of the cleaning-restricted object, and when the sensed object corresponds to the learned information of the cleaning-restricted object as the determination result, the sensed object is determined as the cleaning-restricted object not to be vacuumed, the determination result is stored in the cleaning robot 100, and then the cleaning-restricted object setting mode of the cleaning robot 100 is terminated (S160, S170).

Hereinafter, a process of avoiding an object when the cleaning robot 100 senses an object while moving in a state having learned the information about the cleaning-restricted object will be described with reference to FIG. 8 (S200).

Referring to the drawing, the cleaning robot 100 may map a cleaning space capable of generating the movement path in a state where the cleaning robot 100 has learned the cleaning-restricted object that should be avoided by the cleaning robot 100 and moved (S210).

In an embodiment of the present disclosure, since the cleaning robot 100 is described, for example, as a cleaning robot, the movement path is described, for example, as a cleaning space, but when the cleaning robot 100 is a robot capable of autonomous travel other than the cleaning robot, the movement path may be one of the spaces capable of autonomous travel, and the cleaning robot 100 may map a space capable of autonomous travel.

When the cleaning robot 100 maps the cleaning space, and moves along the generated movement path, the sensor 160 of the cleaning robot 100 may sense an object around the cleaning robot 100 (S220). The sensed object may be determined whether it is a cleaning-restricted object based on the machine learning model described above (S230).

The cleaning-restricted object may be, for example, a product marked as a cleaning-restricted object, a flowable pollutant such as water, a metal object of a predetermined size or less such as a noble metal, or a pollutant containing a predetermined moisture such as defecation of a companion animal living in the home. When the cleaning robot 100 vacuums the cleaning-restricted object made of a metal object such as a valuable or noble metal, for example such as jewelry, among the cleaning-restricted objects, it may cause a failure of the cleaning robot 100, and since the cleaning robot 100 vacuums the cleaning-restricted object containing moisture, and the cleaning robot 100 may further move along the movement path in a state having vacuumed the cleaning-restricted object, the movement path may be further polluted by the cleaning-restricted object, such that it should be determined whether the sensed object is the cleaning-restricted object.

When it is determined that the sensed object is not the cleaning-restricted object, the cleaning robot 100 may continue to travel, and the cleaning-restricted object setting mode of the cleaning robot 100 may be terminated (S270, S280).

Alternatively, when it is determined that the sensed object is the cleaning-restricted object, the positional region of the sensed object may be calculated (S240). Specifically, in order for the cleaning robot 100 to avoid the object determined as the cleaning-restricted object and move, it should be determined whether the object is distributed to any degree of width.

The measurement of the region of the object may be meant to measure the width where the object has been distributed on the movement path of the cleaning robot 100. This is because it is possible to calculate the avoidance path, which may avoid the object determined as the cleaning-restricted object, only when it is determined what the object is distributed to any degree of the width.

For this purpose, it is preferable that the movement path through which the cleaning robot 100 moves is partitioned into a constant width. Since the movement path is partitioned by a constant width, it may be determined whether the object is distributed to any degree of the width.

As described above, when it is determined that the object is distributed to any degree of the width, a new movement path where the cleaning robot 100 may avoid the region where the object has been distributed to move may be reset to calculate the avoidance path (S250).

As described above, once the avoidance path is calculated, the movement path previously stored in the cleaning robot 100 may be reset to progress the movement according to the avoidance path (S260). Accordingly, it is possible to prevent the cleaning robot 100, which automatically vacuums foreign substances around itself, from vacuuming the cleaning-restricted object during movement.

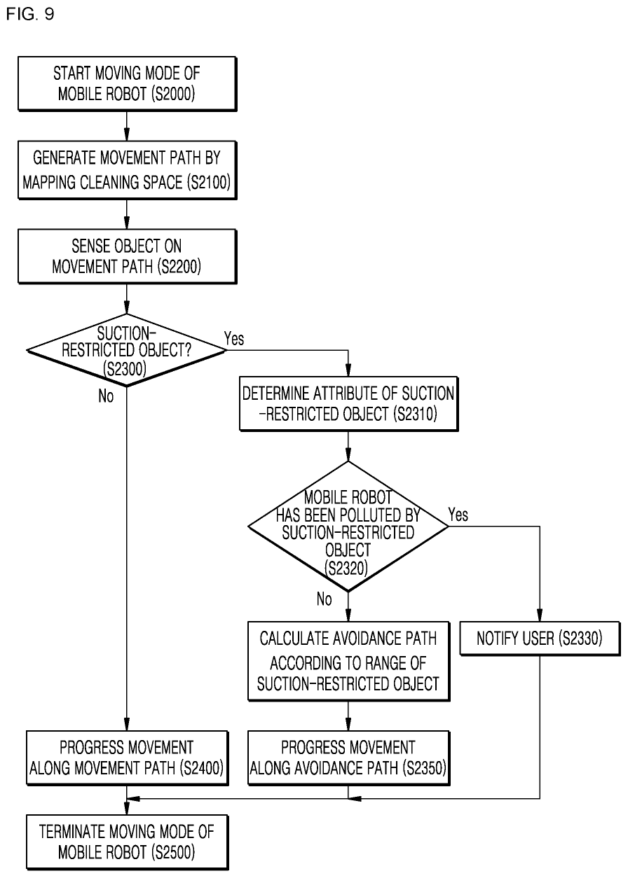

Meanwhile, the cleaning robot 100 may vacuum the object even in any situation of a state where the cleaning robot 100 has recognized that the sensed object is the cleaning-restricted object, or a state where it has not recognized that the sensed object is the cleaning-restricted object. Particularly, the vacuumed object may be a cleaning-restricted object. In this case, a method for driving the cleaning robot 100 will be described with reference to FIG. 9.

FIG. 9 is a flowchart showing a driving limitation of the cleaning robot, when the cleaning robot vacuums the cleaning-restricted object during movement in a state having learned the cleaning-restricted object of FIG. 7.

Before describing the drawing, the cleaning robot 100 is in a state having learned the cleaning-restricted object that should be avoided to move. The cleaning robot 100 may map a cleaning space capable of generating the movement path (S2100).

When the cleaning robot 100 moves along the generated movement path, the sensor 160 of the cleaning robot 100 may sense an object around the cleaning robot 100 (S2200). It may be determined whether the sensed object is a cleaning-restricted object based on the machine learning model described above (S2300).

When the cleaning robot 100 vacuums the cleaning-restricted object made of a metal object such as a noble metal, for example, among the cleaning-restricted objects, it may cause a failure of the cleaning robot 100, and since the cleaning robot 100 may vacuum the cleaning-restricted object containing moisture, and the cleaning robot 100 may further move along the movement path in a state having vacuumed the cleaning-restricted object, the movement path may be further polluted by the cleaning-restricted object, such that it should be determined whether the sensed object is a cleaning-restricted object.

When it is determined that the sensed object is not the cleaning-restricted object, the cleaning robot 100 may continue to travel, and the cleaning-restricted object setting mode of the cleaning robot 100 may be terminated (S2400, S2500).

Alternatively, when it is determined that the sensed object is the cleaning-restricted object, it is determined whether the cleaning robot 100 has been polluted by the cleaning-restricted object (S2310, S2320).

When the cleaning robot 100 is not polluted by the cleaning-restricted object, as described above, the positional region of the sensed object may be calculated, and then the avoidance path of the cleaning robot 100 may be calculated in a range of the cleaning-restricted object (S2340). Thereinafter, the cleaning robot 100 may move along the avoidance path where the cleaning robot 100 may move by avoiding the region where the object has been distributed (S2350).

As described above, when the avoidance path is calculated, the movement path previously stored in the cleaning robot 100 may be reset to progress the movement along the avoidance path. Accordingly, it is possible to prevent the cleaning robot 100, which automatically vacuums foreign substances around itself, from vacuuming the cleaning-restricted object during movement.

Alternatively, when it is determined that the cleaning robot 100 has been polluted by the cleaning-restricted object, the driving of the cleaning robot 100 is controlled. For example, the movement of the cleaning robot 100 is stopped to additionally move, thereby preventing the surrounding region not polluted by pollutants from being polluted.

At the same time, the user of the cleaning robot 100 may be notified of whether the cleaning-restricted object has been vacuumed (S2330). The user may confirm the traveling state of the cleaning robot 100 in real time through a mobile terminal, a personal wearable device, etc. communicatively connected with the cleaning robot 100. Accordingly, even when vacuuming the cleaning-restricted object, the cleaning robot 100 may notify the mobile terminal, the wearable device, etc. of the user so that the user may promptly response thereto.

For example, when the cleaning robot 100 vacuums a pollutant containing moisture or a material made of a metal material, the user may remove the pollutant from the cleaning robot 100 when recognizing it. Accordingly, it is possible to prevent the cleaning robot from moving in a state where the pollutant containing moisture has been attached to the cleaning robot 100, thereby preventing a space where the cleaning robot 100 moves from being re-polluted. Further, since the cleaning-restricted object of the metal material is removed from the cleaning robot 100, it is possible to prevent a failure of the cleaning robot 100 from occurring by a material of the metal material.

As described above, in the process in which the cleanable cleaning robot moves along the movement path, it is possible to avoid the cleaning-restricted object such as a flowable pollutant, an object of a predetermined size or less, or a pollutant containing a predetermined moisture without suction. Accordingly, the cleaning robot may vacuum the pollutant containing moisture during cleaning, and prevent the cleaned region from being re-polluted by the pollutant. Further, suction of a material of a metal material, etc. may be restricted, thereby minimizing occurrence of a failure of the cleaning robot.

Further, the cleaning robot may machine-learn the data set labeled as the cleaning-restricted object not to vacuum the cleaning-restricted object, and the learned information of the cleaning-restricted object may be information for determining whether the object sensed by the cleaning robot is a cleaning-restricted object. That is, when an object around the cleaning robot is sensed, it is possible to prevent the sensed object based on the learned data from being vacuumed when the sensed object is a cleaning-restricted object. Accordingly, the cleaning robot may autonomously avoid the cleaning-restricted object.

Further, when the cleaning robot learns the cleaning-restricted object and then vacuums the cleaning-restricted object while moving along the movement path, the cleaning robot may notify the user of the cleaning robot of whether the cleaning-restricted object has been vacuumed while stopping the driving of the cleaning robot. For example, when the cleaning robot sucks a pollutant containing moisture, a material made of a metal material, etc., the user is notified of it so that the user promptly removes the cleaning-restricted object from the cleaning robot, thereby preventing the cleaning efficiency of the cleaning robot from being lowered.

Further, although it has been described that all of the components constituting an embodiment of the present disclosure are coupled to one or coupled to operate, the present disclosure is not necessarily limited to these embodiments, and that all of the components may also be operated by being selectively coupled to one or more within the scope of the present disclosure. Further, although all of the components may be implemented as a single independent hardware, respectively, some or all of the respective components may also be implemented as a computer program having a program module for performing some or all of the functions combined in a single hardware or a plurality of hardwares by being selectively combined. Codes and code segments constituting the computer program may be easily inferred by those skilled in the art. The computer program may be stored in a computer-readable storage media to be read and executed by a computer, thereby implementing an embodiment of the present disclosure. The storage medium of the computer program includes a magnetic recording media, an optical recording media, and a storage media including a semiconductor recording element. Further, a computer program implementing an embodiment of the present disclosure includes a program module that is transmitted in real time through an external apparatus.

As described above, while a specific embodiment of the present disclosure has been described and shown, the present disclosure is not limited to the described embodiment, and it may be understood that various modifications and variations may be made by those skilled in the art as other specific embodiments without departing the spirit and scope of the present disclosure. Accordingly, the scope of the present disclosure is not defined by the described embodiment but should be defined by the technical spirit recited in the claims.

As described above, while it has been described by focusing an embodiment of the present disclosure, various modifications or variations may be made within the level of those skilled in the art. Accordingly, it may be understood that these modifications and variations are included within the scope of the present disclosure as long as it does not depart the scope of the present disclosure.

1. A method for operating a cleaning robot, the method comprising:
projecting an electromagnetic wave toward a movement path in which the cleaning robot is moving;
sensing an object positioned on the movement path based on electromagnetic waves reflected from the object;
determining whether the sensed object is a type of restricted object by inputting information of the reflected electromagnetic waves to a machine learning model trained to determine whether an object is a type of restricted object based on an input of electromagnetic wave information associated with the object;
measuring an area corresponding to the sensed object when the sensed object is determined to be a type of restricted object;
calculating an avoidance path to avoid the measured area and changing the movement path based on the calculated avoidance path; and
operating the cleaning robot to avoid the sensed object based on the changed movement path.

2. The method of claim 1,
wherein the machine learning model is trained using a training data set comprising images of a flowable pollutant, a metal object of a predetermined size or smaller, or a pollutant containing a predetermined moisture, which are labeled as restricted objects.

3. (canceled)

4. The method of claim 1,
wherein the sensed object is determined to correspond to a restricted object when the object is determined to be liquid based on the electromagnetic wave reflected by the object.

5-6. (canceled)

7. The method of claim 1, further comprising:
stopping movement of the cleaning robot when a restricted object has been cleaned; and
transmitting a notification to a user indicating that the restricted object has been cleaned.

8. A cleaning robot comprising:
one or more sensors;
a driving unit;
a projecting unit;
a memory; and
one or more processors configured to:
project, via the projecting unit, an electromagnetic wave toward a movement path in which the cleaning robot is moving by operation of the driving unit;
sense, via the one or more sensors, an object positioned on the movement path based on electromagnetic waves reflected from the object;
determine whether the sensed object is a type of restricted object by inputting information of the reflected electromagnetic waves to a machine learning model stored in the memory, wherein the machine learning model is trained to determine whether an object is a type of restricted object based on an input of electromagnetic wave information associated with the object;
measure an area corresponding to the sensed object based on information sensed by the one or more sensors when the sensed object is determined to be a type of restricted object;
calculate an avoidance path to avoid the measured area and changing the movement path based on the calculated avoidance path; and
operate the driving unit to avoid the sensed object based on the changed movement path.

9. The cleaning robot of claim 8,
wherein the machine learning model is trained using a training data set comprising images of a flowable pollutant, a metal object of a predetermined size or smaller, or a pollutant containing a predetermined moisture, which are labeled as restricted objects.

10. (canceled)

11. The cleaning robot of claim 8,
wherein the one or more processors are further configured to determine the object as corresponding to a restricted object when the object is determined to be liquid based on the electromagnetic wave reflected by the object.

12-14. (canceled)

15. The cleaning robot of claim 8, further comprising a transceiver, wherein the one or more processors are further configured to transmit a notification to a user via the transceiver when a restricted object has been suctioned by the cleaning robot.

16. The cleaning robot of claim 8, wherein the cleaning robot is configured to clear debris by vacuuming.

17. The cleaning robot of claim 8, wherein the cleaning robot is configured to clear debris by sweeping or mopping.
